(19) United States
(12) Patent Application Publication
(10) Pub. No.: US 2007/0251956 A1
(43) Pub. Date: Nov. 1, 2007

(54) Pour spout for a beverage dispenser

(75) Inventors: David M. Wasserman, Whitefish Bay, WI (US); Rebecca J. Schreiber-Pethan, Sheboygan, WI (US); Mark V. LeGreve, Two Rivers, WI (US)

Correspondence Address: FOLEY & LARDNER LLP, 777 EAST WISCONSIN AVENUE, MILWAUKEE, WI, 53202-5306, US

(73) Assignee: The Vollrath Company, L.L.C.

(21) Appl. No.: 11/412,284

(22) Filed: Apr. 27, 2006

(51) Int. Cl. B67D 5/58

(52) U.S. Cl. 222/189.07

(57) ABSTRACT

A beverage container assembly for dispensing a liquid is disclosed. The beverage container assembly comprises a container for containing the liquid and having a mouth, a top removably coupled to the container and extending across the mouth. The top comprises a pour spout, a strainer, and a plurality of air relief passages. The air relief passages are configured to allow air to flow into the container as the fluid is being poured out of the container through the strainer.

### BACKGROUND

The present invention relates generally to the field of beverage containers and dispensers. More specifically, the present invention relates to the field of beverage containers that have a strainer, such as cocktail shakers, to control the contents that are allowed to flow out of the container.

It is known to provide cocktail shakers or other beverage dispensers with a strainer to allow liquid to be poured from the container and retain certain solid matter, such as ice cubes, in the container. However, known beverage dispensers such as cocktail shakers have several disadvantages. For example, the lid and strainer of known beverage dispensers do not allow for smooth pouring from the container. The design of known cause the liquid to gurgle, sputter, and splash out of the container as air attempts to enter the container to replace the exiting fluid. This resulting in spilling, and sporadic and uneven pouring. Also, such known shakers do not have insulation properties that keeps the liquid at the desired temperature or reduces or prevents condensation from building or accumulating on the exterior of the container.

Accordingly, it would be advantageous to provide a beverage dispenser with a strainer and cover that includes features configured to aid the passage of air into a container to replace liquid being poured out of the container. It would also be advantageous to provide a cover container that is configured to provide relatively smooth pouring in multiple orientations. It would further be advantageous to provide a beverage dispenser that maintains the contents at a desired temperature and/or reduces condensation from accumulating on the exterior of the container. To provide an inexpensive, reliable, and widely adaptable beverage dispenser that avoids the above-referenced and other problems would represent a significant advance in the art

### SUMMARY

The present invention relates to a beverage container assembly for dispensing a liquid. The beverage container assembly comprises a container for containing the liquid and having a mouth, a top removably coupled to the container and extending across the mouth. The top comprises a pour spout, a strainer, and a plurality of air relief passages. The air relief passages are configured to allow air to flow into the container as the fluid is being poured out of the container through the strainer.

The present invention also relates to a beverage dispensing assembly comprising a container for containing the liquid and having a mouth, a top removably coupled to the container and extending across the mouth. The top comprises a pour spout, a strainer, a plurality of air relief slots extending through the top, and a plurality of air relief channels on an interior surface of the pour spout and aligned with the slots. The air relief slots are intended to allow air to flow into the container as the fluid is being poured out of the container through the strainer. The air relief channels are intended to provide an unobstructed passage to allow air to flow from the air relief slots into the container as the fluid is being poured out of the container through the strainer.

The present invention further relates to a container assembly comprising a container having a circular mouth and a non-circular top removably coupled to the container and extending across the mouth. The top comprises a perforated pouring portion that is eccentric with respect to a center line of the container.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow

### BRIEF DESCRIPTION OF THE DRAWINGS

FIG. 1 is a schematic view of a container with a pour spout.

FIG. 2 is an elevation view of a container and pour spout according to an exemplary embodiment.

FIG. 3 is a cross-section of the container and pour spout in FIG. 2 taken along line 3-3.

FIG.4A is detail of the pour spout in FIG.3.

FIG. 4B is a detail of the pour spout in FIG. 3 tipped in the orientation in FIG. 1, showing the air passages and bevels.

FIG. 5 is a bottom plan view of the pour spout in FIG. 2.

FIG. 6 is an exploded view of a container with a pour spout according to another exemplary embodiment.

FIG. 7 is an exploded view of the pour spout in FIG. 6

FIG. 8 is a section view of the pour spout in FIG. 6.

FIGS. 9-10 are schematic views of a canister and pour spout according to other exemplary embodiments.

### DETAILED DESCRIPTION OF THE PREFERRED AND EXEMPLARY EMBODIMENTS

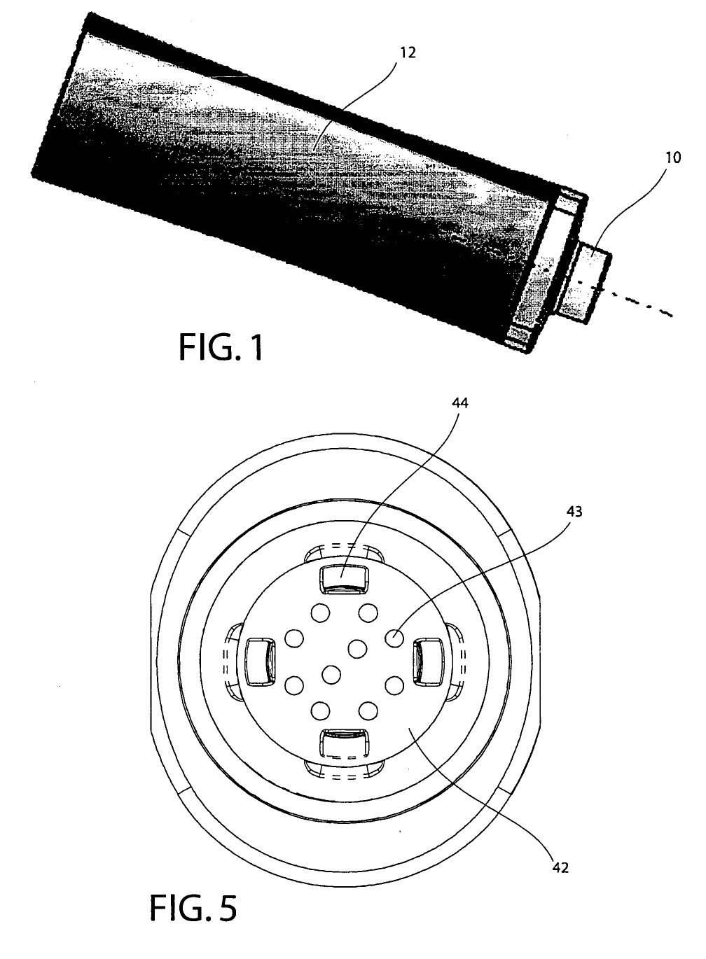

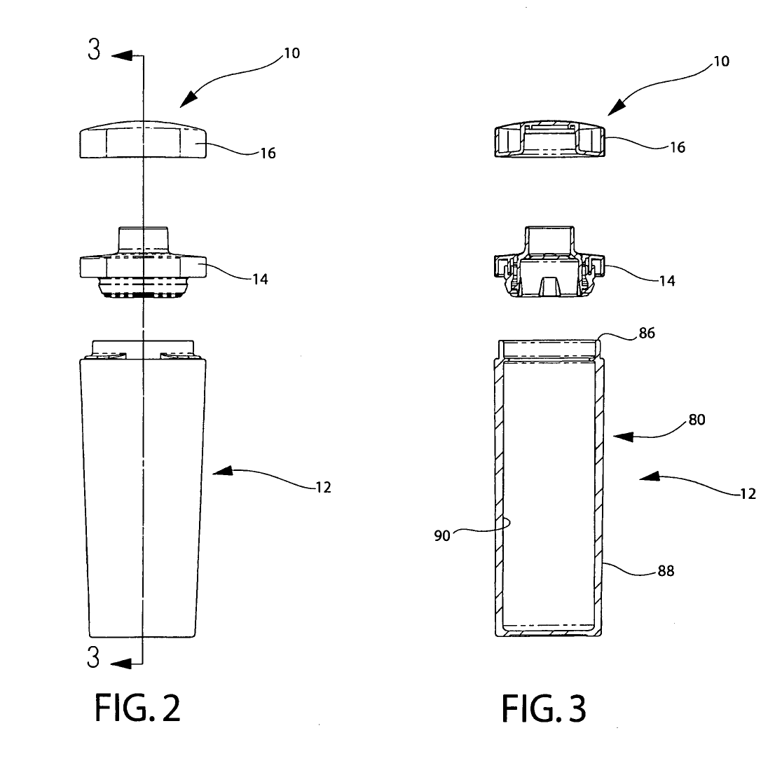

Referring to FIGS. 1-5, a beverage container or dispenser is shown according to an exemplary embodiment. The beverage dispenser is configured to retain a liquid, provide a receptacle for mixing a beverage, and/or pour at least a portion of the mixture into a glass. According to an exemplary embodiment, the beverage container is a cocktail shaker (as shown in the FIGURES). The beverage dispenser generally includes a top or lid 10 removably coupled to a container 12. According to a preferred embodiment, the lid 10 includes air relief passages and channels for liquid to be poured smoothly from a container, and container is configured to maintain the contents at a desired temperature and reduce condensation from accumulating on the outside of container 12.

Lid 10 comprises a lower portion 14 that is coupled to container 12 and an upper portion 16 that is coupled to lower portion 14. Lower portion 14 comprises a pour spout 20, a mounting portion 22, a gasket 24, and a shell 26.

Spout 20 provides a passage for a liquid to be poured from (e.g., dispensed, escape, etc.) container 12. Spout 20 comprises a pour sleeve or guide 40, a strainer 42, a plurality of air relief passages 44, a plurality of air relief channels 46, a groove 48 and two ribs 50.

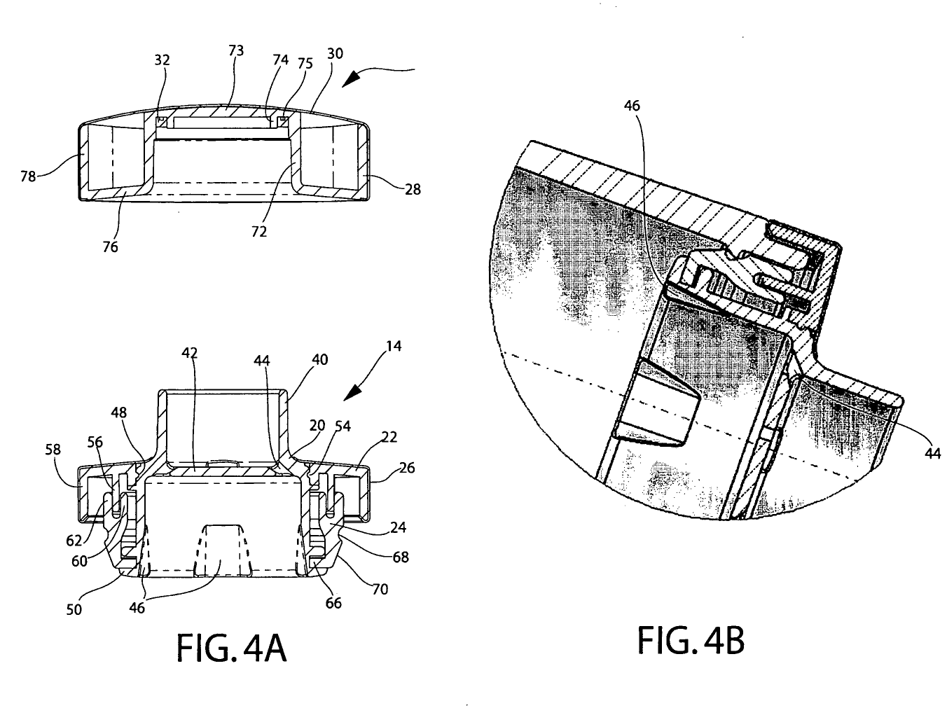

Pour guide 40 is a generally cylindrical feature that acts as a channel for a liquid being poured from container 12. Pour guide 40 may have a variety of configurations, and is shown as an upwardly extending cylindrical ring. As shown in FIG. 4A, guide 40 extends upwardly as a cylindrical ring above strainer 42 and extends downwardly into container 12.

Strainer 42 is provided approximately halfway along the inner surface of pour guide 40. Strainer 42 is a flat surface (e.g. plate, wall, partition, barrier, etc.) that comprises a plurality of perforations 43 and air passages 44. Perforations 43 are shown as generally circular openings (e.g., apertures, passages, holes, etc.) in strainer 42 that allow a liquid to pass through strainer 42 when container 12 is upended while retaining any object larger than perforations 43 (e.g., ice cubes) inside container 12. According to alternative embodiments, perforations may be any of a variety of shapes (e.g., elongated, ovular, elliptical, rectangular, square, etc.) and sizes (i.e., to retain the desired matter within the container 12) and be spaced apart in a variety of patterns and distances. According to an exemplary embodiment, strainer 42 is integrally formed with pour guide 40 as a one-piece, unitary component, such as in an injection molding operation.

According to a preferred embodiment, air relief passages 44 and channels 46 are configured to allow liquid to be poured smoothly from container 12 by allowing air to flow into the container to occupy the volume left by the displaced liquid. Fluid being poured from container 12 is replaced with air. When air is not allowed to freely enter the container, the entering air interrupts the flow of the liquid, causing the liquid to “gurgle,” which may result in spilling and sporadic and uneven pouring.

Air relief passages 44 (e.g., slots, apertures, etc.) are distributed around the circumference of strainer 42 near pour guide 40, and outside of perforations of strainer 42. The positioning and spacing of air passages 44 are intended to allow at least one air passage 44 to be above perforations 43 when a user upends container 12 to pour the liquid out of container 12. According to a preferred embodiment, air passages 44 are orientated and positioned so that at least one is positioned above the apertures regardless of the relative orientation of lid 10 and container 12.

Channels 46 are features provided on spout 20 below air passages 44 and are generally aligned with air passages 44. Channels 46 are depressions (e.g., bevels, grooves, etc.) that provide passages (i.e., removes structural restrictions) for air to flow into the container 12 from air passages 44 to replace the space from fluid as it is poured out of container 12. According to exemplary embodiments air relief channels 46 are orientated, shaped, and/or angled to reduce or minimize destruction of air flow that enters the canister to replace outgoing liquid.

Groove 48 is provided on spout 20 approximately halfway along the outside surface of spout 20. Groove 48 is a depression (e.g., cut, gouge, channel, furrow, etc.) extending inward along the circumference of the outer surface of spout 20 that is configured to receive a feature on mounting portion 22.

Ribs 50 are provided near the bottom of spout 20 and extend outward from the outer surface of spout 20. Ribs 50 are separated by a channel that is configured to receive a feature on gasket 24. According to an exemplary embodiment, spout 20 is formed of a polycarbonate polymer. According to other exemplary embodiments, spout 20 may be any of a variety of polymers or any other suitable material.

Mounting portion 22 is a generally annular body substantially surrounds and retain spout 20. Mounting portion 22 engages the top mouth of container 12 (e.g., generally covers the top of container 12) and is configured to form a substantially smooth, continuous contour with container 12. Mounting portion 22 comprises a ridge 54, a rib 56, and a skirt 58. Ridge 54 is provided near the top of mounting portion 22 along the inside surface of mounting portion 22. Ridge 54 is a protrusion (e.g., bead, lip, extension, etc.) that is configured to be received by groove 48 on spout 20 to at least partially couple mounting portion 22 to spout 20. Rib 56 is a generally thin circular wall that extends downward from the bottom of mounting portion 22. Rib 56 is configured to be received by a feature in gasket 24. Skirt 58 is a generally thin wall that is generally downwardly extending about the periphery of pour guide 40 and substantially parallel to the side wall of container 12. Skirt 58 generally provides a continuous contour with container 12. Skirt 58 is configured to provide a space between its inner surface and spout 40 and/or gasket 24 that receives the rim that defines the mouth of container 12. According to an exemplary embodiment, mounting portion 22 is formed of an acrylonitrile butadiene styrene (ABS) polymer. According to other exemplary embodiments, mounting portion 22 may be another type of polymer or any other suitable material. According to an exemplary embodiment, the mounting portion is integrally formed with pour guide 40 (and/or strainer 42) as a one-piece, unitary component, such as in an injection molding operation.

Gasket 24 is a sealing member coupled between container 12 and lower portion 14. Gasket 24 is a generally ring-shaped body and comprises an inner side wall 60, an outer side wall 62, an inwardly extending flange 66, a groove 68 and a sloped surface 70. Inner side wall 60 and outer side wall 62 are generally parallel and are separated by a channel that is configured to receive rib 56 on mounting portion 22. Flange 66 is generally perpendicular to inner side wall 60 and is received between ribs 50 on spout 20 to at least partially couple spout 20 to gasket 24. A groove 68 is provided on gasket 24 approximately halfway along outside side wall 62. Groove 68 is a depression (e.g., cut, gouge, channel, furrow, etc.) extending inward along the circumference of outer side wall 62 that is configured to receive a feature on container 12 to at least partially couple lower body 14 to container 12. Sloped surface 70 extends downward below groove 68 on outer side wall 62 and is configured to guide lower portion 14 into container 12. According to an exemplary embodiment, gasket 24 is silicone. According to other exemplary embodiments, gasket could be any material suitable for sealing the area between lower portion 14 and container 12 and coupling lower portion 14 to container 12 (e.g., polychloroprene rubber, nitrile rubber, etc.).

Lower portion 14 may be partially surrounded by an outer member, shown as shell 26. Shell 26 is configured to provide a decorative appearance as well as a surface that minimizes maintenance, and is easy to clean and/or sanitize. According to an exemplary embodiment, shell 26 is stainless steel sheet metal and is shaped (e.g., stamped) so that is generally follows the profile of spout 20 and mounting portion 22. Shell 26 is affixed to lower portion 14 (e.g., with an adhesive) and is configured to increase the resistance of lower body 14 to surface disfigurement (e.g., scratches, dings, gouges, etc.). Shell 26 may also be configured to enhance the aesthetic appearance of lid 10 or to match the appearance of container 12.

Upper portion 16 comprises a cover 28, a shell 30, and a gasket 32. Cover 28 is a thin-walled body that is configured to fit over spout 20 and reduce the likelihood of any liquid in container 12 escaping. Cover 28 comprises a central cup 72, a side wall 78 and a web 76 that connects cup 72 and side wall 78. Cup 72 is configured to fit relatively snugly over pour guide 40. Cup 72 has a closed end 73 with a generally circular rib 74 that forms a channel 75. Web 76 is a generally thin, annular body that extends outward from closed end of cup 72. Side wall 78 extends upward from web 76, generally perpendicular to web 76 and is approximately the same height as cup 72. Side wall 78 is configured to substantially match the side walls of container 12 so that upper portion 16 and container 12 form a substantially continuous contour when upper portion 16 is coupled to lower portion 14. According to an exemplary embodiment, cover 28 is formed of an acrylonitrile butadiene styrene (ABS) polymer. According to other exemplary embodiments, cover 28 may be another type of polymer or any other suitable material.

Upper portion 16 may be partially surrounded by an outer member, shown as shell 30. Shell 30 is configured to provide a decorative appearance as well as a surface that minimizes maintenance, and is easy to clean and/or sanitize. According to an exemplary embodiment, shell 30 is stainless steel sheet metal and is shaped (e.g., stamped) so that is generally follows the profile of cover 28. Shell 30 is affixed to cover 28 (e.g., with an adhesive) and is configured to increase the resistance of cover 14 to surface disfigurement (e.g., scratches, dings, gouges, etc.). Shell 30 may also be configured to enhance the aesthetic appearance of lid 10 or to match the appearance of canister 14.

Upper portion 16 may also include a sealing member, shown as gasket 32. According to one exemplary embodiment, gasket 32 is a ring-shaped member with a circular cross-section. Gasket is received in channel 75 on cap 72 and provides a sealing surface for the rim of pour guide 40. According to an exemplary embodiment, gasket 32 is silicone. According to other exemplary embodiments, gasket could be any material suitable for sealing the area between pour guide 40 and upper portion 16 (e.g., polychloroprene rubber, nitrile rubber, etc.).

Container 12 (e.g., receptacle, vessel, canister, etc.) comprises a body 80 that defines an interior space 84. Body 80 preferably comprises a mouth or rim 86, an outer shell or wall 88, and an inner shell or wall 90. Rim 86 defines an opening through which liquid and/or solid product is added and poured out of container 12. Outer wall 88 is spaced apart from the inner wall 90 to provide insulation properties and reduce the accumulation of condensation on the outside surface of container 12. The space between outer wall 88 and inner wall 90 may be provided as a vacuum or contain air or an insulation material.

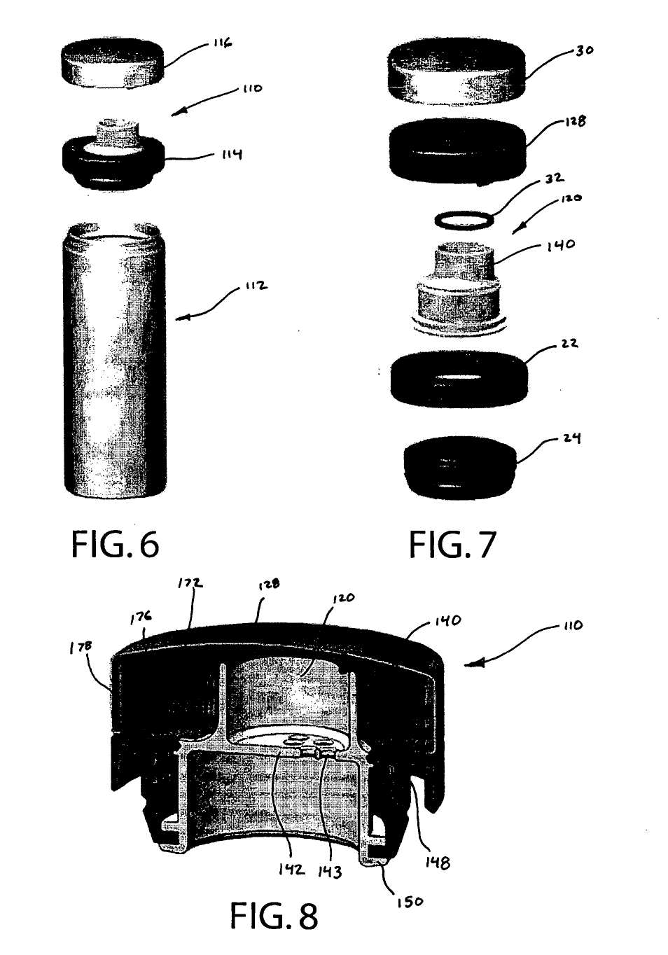

Referring to FIGS. 6-8, a pour spout lid or top 110 is shown according to another exemplary embodiment. Top 110 comprises a lower portion 114 that is coupled to container 112 and an upper portion 116 that is coupled to lower portion 114. Lower portion 114 comprises a pour spout 120, a mounting portion 22, and a gasket 24. Top 110 differs from top 10 at least in that spout 120 is eccentric (e.g., offset) with respect to a center line of container 112.

Spout 120 provides a passage for a liquid to poured from container 112 and comprises a pour guide 140, a strainer 142, a groove 148 and two ribs 150. Pour guide 140 is a generally cylindrical feature that acts as a channel for a liquid being poured from container 112. Pour guide 140 is eccentric to the central axis of container 112 and is configured to urge a user to use a preferred orientation when upending container 112 to pour a liquid from container 112. In a preferred orientation, pour guide 140 is substantially below the central axis of container 112. A strainer 142 is provided approximately midway (halfway) along the inner surface of pour guide 140.

Strainer 142 is a flat surface (e.g. plate, wall, partition, barrier, etc.) that comprises a plurality of perforations 143. Perforations 143 are shown as generally circular openings (e.g., apertures, passages, holes, etc.) in strainer 142 that allow a liquid to pass through strainer 142 when container 112 is upended while retaining any object larger than perforations 143 (e.g., ice cubes) inside container 112. According to an exemplary embodiment, perforations 143 are disposed away from the central axis of container 112 and towards the side wall of pour guide 140. A groove 148 is provided on spout 120 approximately halfway along the outside surface of spout 120.

Upper portion 116 comprises a cover 128, a shell 30, and a gasket 32. Cover 128 comprises a central cup 172, a side wall 178 and a web 176 that connects cup 172 and side wall 178. Cup 172 is eccentric to the center axis of container 112 and configured to fit relatively snugly over pour guide 140.

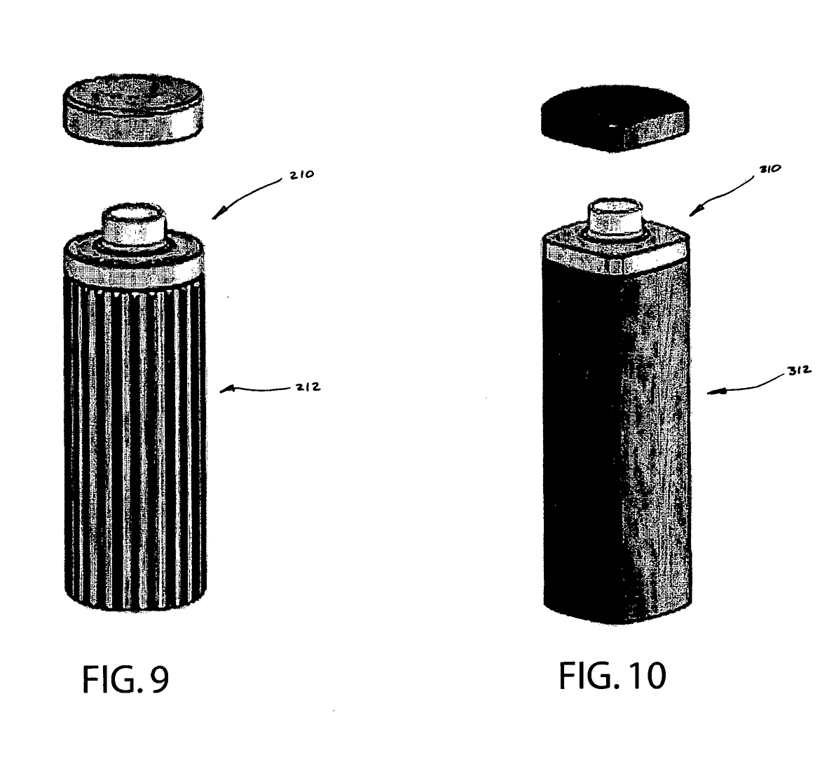

According to one exemplary embodiment, canister has a generally smooth and cylindrical side wall. According to FIGS. 9-10 and other exemplary embodiments, container 12 may have a sidewall with ridges or a non-circular cross section. FIG. 9 illustrates a lid 210 for a container 212 with a ridged, generally round side wall. FIG. 10 illustrates a lid 310 for a container 312 with a smooth, generally square side wall.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is important to note that the construction and arrangement of the elements of the pour spout cover provided herein are illustrative only. Although only a few exemplary embodiments of the present invention have been described in detail in this disclosure, those skilled in the art who review this disclosure will readily appreciate that many modifications are possible in these embodiments (such as variations in features such as components, lids, covers, perforation patterns, use of materials, colors, contours, combinations of shapes, etc.) without materially departing from the novel teachings and advantages of the inventions. For example, components that are shown as separate bodies could be a single unitary body (e.g., the spout and lid), the upper portion could be coupled to the lower portion with a threaded connection, or the number and distribution of air passages and bevels could vary. Further, it is readily apparent that variations of the pour spout cover may be provided in a wide variety of types, shapes, sizes, and perforation patterns for use with a wide variety of canister sizes, shapes and appearances. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims

What is claimed is:

1. A beverage container assembly for dispensing a liquid comprising:
a container for containing the liquid and having a mouth;
a top removably coupled to the container and extending across the mouth, the top having a pour spout, a strainer, and a plurality of air relief passages;
wherein the air relief passages are configured to allow air to flow into the container as the fluid is being poured out of the container through the strainer.

2. The beverage container assembly of claim 1 wherein the air relief passages comprise a plurality of slots extending through the top so that the interior of the container is in communication with the ambient air.

3. The beverage container assembly of claim 2 further comprising a plurality of air relief channels on an interior surface of the pour spout.

4. The beverage container assembly of claim 3 wherein the channels are aligned with the slots.

5. The beverage container assembly of claim 4 wherein the strainer comprises a plurality of openings located inside of the plurality of slots.

6. The beverage container assembly of claim 5 wherein the plurality of slots comprises four slots spaced at quadrants outside a circular periphery of the openings on the strainer.

7. The beverage container assembly of claim 6 wherein the top further comprises a mounting portion and a gasket wherein the mounting portion and the gasket define a space configured to receive the mouth of the container.

8. The beverage container assembly of claim 7 wherein the container and top form a cocktail shaker.

9. The beverage container assembly of claim 1 further comprising a cover removably coupled to the top.

10. A beverage dispensing assembly comprising:
a container for containing the liquid and having a mouth;
a top removably coupled to the container and extending across the mouth, the top having a pour spout, a strainer, a plurality of air relief slots extending through the top, and a plurality of air relief channels on an interior surface of the pour spout and aligned with the slots;
wherein the air relief slots allow air to flow into the container as the fluid is being poured out of the container through the strainer;
wherein the air relief channels provide an unobstructed passage to allow air to flow from the air relief slots into the container as the fluid is being poured out of the container through the strainer.

11. The beverage dispensing of claim 10 wherein the strainer comprises a plurality of openings located inside of the plurality of slots.

12. The beverage dispensing of claim 1 1 wherein the plurality of slots comprises four slots spaced at quadrants outside a circular periphery of the openings on the strainer.

13. The beverage dispensing of claim 10 wherein the top further comprises a mounting portion and a gasket wherein the mounting portion and the gasket define a space configured to receive the mouth of the container.

14. The beverage dispensing of claim 13 wherein the container and top form a cocktail shaker.

15. The beverage dispensing of claim 10 further comprising a cover removably coupled to the top.

16. A container assembly comprising:
a container having a circular mouth; and
a non-circular top removably coupled to the container and extending across the mouth, the top having a perforated pouring portion eccentric with respect to a center line of the container.

17. The assembly of claim 16 further including a spout about the perforated portion.

18. The assembly of claim 17 wherein the pour spout has a diameter of at least about 0.75 inches.

19. The assembly of claim 17 wherein the pour spout has a circular axial cross-section and wherein the pouring portion includes perforations eccentric with respect to a center line of the pour spout.

20. The assembly of claim 16 wherein the container has a non-circular axial cross-section.

21. The assembly of claim 20 wherein the non-circular cross-section of the top and the non-circular axial cross-section of the container are substantially similar such that the top and the container are flush.

22. The assembly of claim 16 wherein the top includes a channel receiving a rim of the container.
